(19) United States
(12) Patent Application Publication
(10) Pub. No.: US 2011/0320587 A1
(43) Pub. Date: Dec. 29, 2011

(54) REAL-TIME DETERMINATION OF SOFTWARE INSTALLATION STATUS

(75) Inventor: Brice Richard Ballesteros, Arlington, VA (US)

(73) Assignee: UNISYS CORPORATION, BLUE BELL, PA (US)

(21) Appl. No.: 12/825,404

(22) Filed: Jun. 29, 2010

(51) Int. Cl. G06F 15/173

(52) U.S. Cl. 709/224

(57) ABSTRACT

A computer-implemented method for real-time determination of software installation status is described. The determination is performed for multiple computing devices. The method includes accepting a list of computing devices connected to a network. Further, the method includes receiving an identifier for a software component and determining installation status for the software component based on the identifier. The determination being performed on each computing device in the list in real-time. Further, the method includes producing a software installation report based on the determined installation status.

### BACKGROUND

This application deals generally with the field of network administration, and more specifically with tracking software installations in the network.

Network administration is a tedious task involving management of servers, workstations, and networks. Typically, network administration encompasses a number of diverse aspects, such as network design, management, and troubleshooting. Network management involves software and hardware configuration management. Among these, installing software components or updates on a network is a difficult task for the network administrators.

In conventional network administration tools, software installation involves monitoring and surveillance of the network before deploying the software component. Further, the software installation includes managing software inventory, such as obtaining a list of software applications from every network device and remote installation and un-installation of software applications. In many cases, the administrators need to visit every network machine to check available software version and perform installation or update. In addition, when performed in large networks, these tasks consume a substantial period of time. Particularly, the tools require considerable time between the start of the tasks and retrieval of results.

### SUMMARY

At present, there exists a need in the art to optimize software deployment and management for large networks in companies and organizations, and more specifically, determining software installation status for large networks in real-time. In addition, there is a need to extract the software installation status.

One embodiment of the instant application describes a computer-implemented method and computer program product for real-time determination of software installation status, the determination being performed for multiple computing devices. The method includes accepting a list of computing devices connected to a network. Further, the method includes receiving an identifier for a software component and determining installation status for the software component based on the identifier, the determination being performed on each computing device in the list in real-time. Further, the method includes producing a software installation status report based on the determined installation status.

Another embodiment of the instant application describes a system for real-time determination of software installation status. The system includes a network of multiple computing devices. Further, the system includes an input module for accepting a computing device list and an identifier for a software component for which the installation status is to be determined. The computing device list includes computing devices connected to the network. Further, the system includes a verification module for determining installation status of the software component based on the identifier, the determination being performed for each computing device on the list in real-time. The system includes an output module for producing a software installation status report based on the determined installation status.

### BRIEF DESCRIPTION OF THE DRAWINGS

The drawings described below set out and illustrate a number of exemplary embodiments of the disclosure. Throughout the drawings, like reference numerals refer to identical or functionally similar elements. The drawings are illustrative in nature and are not drawn to scale.

FIG. 1 illustrates an exemplary operating environment for the instant application.

FIG. 2 is a flowchart of an exemplary method for determining software installation status for computing devices in a network.

FIG. 3 depicts an exemplary system for determining software installation status for computing devices in a network.

FIG. 4 is an exemplary screenshot of a graphical user interface (GUI) for determining software installation status for computing devices in a network.

### DETAILED DESCRIPTION

The following detailed description is made with reference to the drawings. Exemplary embodiments are described to illustrate the subject matter of the disclosure, not to limit its scope, which is defined by the appended claims.

### Overview

In general, the instant application discloses a computer-implemented method for real-time determination of software installation status for multiple computing devices. The method accepts a list of computing devices connected to a network, and receives an identifier for a software component. The embodiments of the instant application determine installation status for the software component on each computing device in the list in real-time based on the identifier. In addition, the embodiments of the instant application produce a software installation report based on the determined installation status.

### Definitions

The following terms are used throughout the disclosure and are defined here for clarity and convenience.

Network

A collection of computing devices connected by multiple communication channels facilitating communication among the computing devices.

Active Devices

Devices that are live and have an existing connection with a network.

Inactive Devices

Devices for which network connection has been idle for a certain period of time; in some situations, a timeout may have occurred.

Software Patch

A piece of software designed to fix problems or update a computer program or its supporting data.

### Exemplary Operating Environment

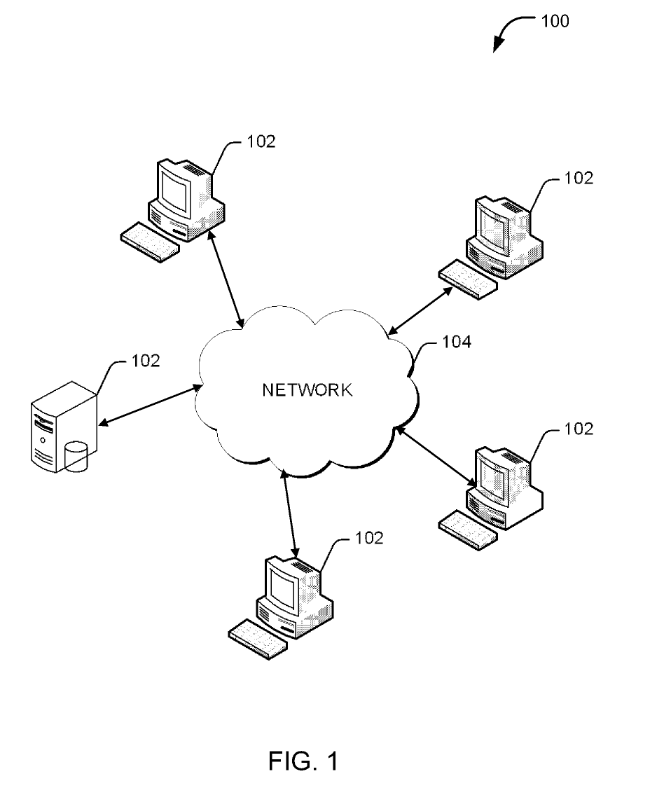

FIG. 1 illustrates an exemplary operating environment 100 for embodiments disclosed in the instant application. The environment 100 includes multiple computing devices 102 connected to a network 104 by a wired or a wireless connection. The environment 100 includes a network administration application that allows a user to search, evaluate, verify, or extract information to determine whether a particular software version or software update is installed on the computing devices 102. The application may reside on any of the computing devices 102, and any user having administrative permissions to the network 104 can execute the application on the computing devices 102. Further, the network 104 can be a local area network (LAN), wide area network (WAN), virtual private network (VPN), storage area network (SAN), or any other network known in the art.

### Specific Description Sections

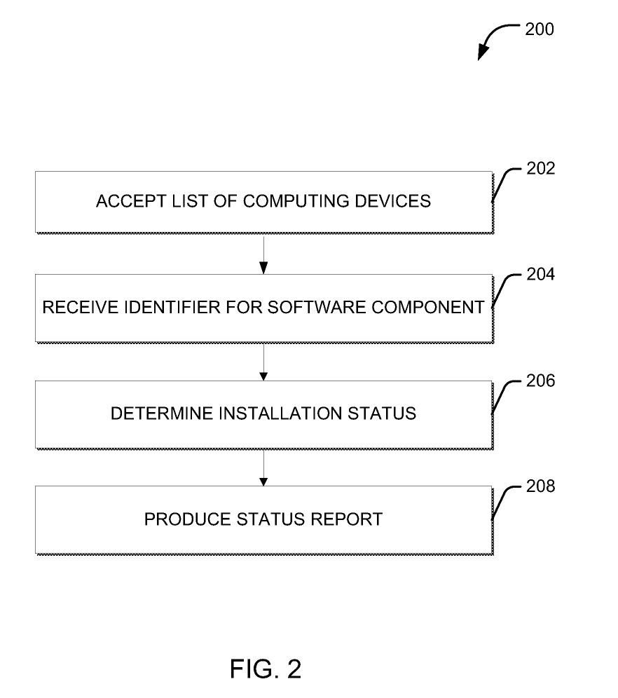

FIG. 2 is a flowchart of an exemplary method 200 for determining software installation status for computing devices in a network. The method 200 accepts a list of computing devices connected to the network at step 202. The method 200 may generate the list of computing devices automatically by pinging the network, or by using other network-monitoring tools that are known in the art. Otherwise, a user may provide the list of computing devices manually through a graphical user interface (GUI).

In one embodiment, the list of computing devices is a list of all the computing devices connected to the network. In the present embodiment, however, the list of computing devices is a list of actively-connected computing devices. The method 200 obtains a list of actively-connected computing devices by performing a network connectivity test for each computing device. The computing devices for which the connectivity test result is positive are included in the list of actively-connected computing devices, while the remaining computing devices are included in a separate list of inactive devices. The list of actively-connected computing devices excludes inactive computing devices.

Further, the method 200 receives an identifier for a software component at step 204. The identifier is related to the software component for which the installation status is to be determined on the computing devices. The GUI enables a user to input the identifier to the method 200. Instead, the user can browse for and select the identifier from an existing list of software components. The existing list may include a comprehensive list of software components such as applications software, updates, or versions, malicious software and other similar components well known to those skilled in the art. The identifier can be a combination of a file path and a file name. The file name can be name of a file associated with the software component. The software component can be a software application, a software version, or a software patch. Alternatively, the software component can be an update to a software component.

At step 206, the method 200 determines the installation status of the software component in real time. The method 200 utilizes the identifier received at the step 204 and searches for the identifier through the file system of each computing device in the list of computing devices actively-connected to the network. The file path is searched through the network for that computing device name and current state of the software component is recorded. After executing the step 206, the current state identified is recorded with a time and date stamp.

In addition, the user may track the number of computing devices being searched through a progress indicator, which is a graphical representation of the searching progress. For example, a well-known progress indicator is a horizontal bar that extends as the search progresses. Otherwise, the GUI may enable display of the progress indicator that changes color in a direction corresponding to the searching being completed. In some embodiments, the progress indicator may be reversible, having any shape that fills corresponding to the searching being completed. The reversible progress indicator can have the shape of a rectangular bar, a circle, or any other appropriate shape. Alternatively, the progress indicator can be any other similar progress indicator known in the art. Additionally, the progress bar may represent a numeric marker indicating the number of computing devices searched so far.

Further, the method 200 produces a software installation status report at step 208. Specifically, the report is based on the installation status determined at the step 206 and includes one or more status indicators, denoting the installation status. The status indicators may include computing device name, a string verifier, a time stamp, a date stamp, or any other indicator that may be evident to those skilled in the art. The string verifier includes a string specifying the current state of the software component. Furthermore, there can be separate string verifiers for positive and negative status results, stating whether the software component is present or absent on a particular computing device. For instance, the positive string verifier can be “Installation Verified” and the negative string verifier can be “Not Installed”. In addition, the method 200 allows the user to modify the status indicators by changing their associated values and can select one or more of these status indicators for inclusion in the report.

In one implementation, the user examines the report on the GUI display. Alternatively, the user exports the report data to a local computing device in a file. The user may copy or cut the entire report data from the GUI and paste in an application on the local computing device. The application can be Microsoft Word, Notepad, Microsoft Excel, Novell Open Office Write, or any other similar application known in the art. Otherwise, the user can export the result data into a Microsoft Excel comma-separated value spreadsheet (CSV) file.

Furthermore, upon completion of the status report production, the user can terminate the method 200 from the GUI or perform the determination again for another list of computing devices. In addition, the user can temporarily pause or permanently abort the method 200 during execution from the GUI, without any negative impact on the computing devices.

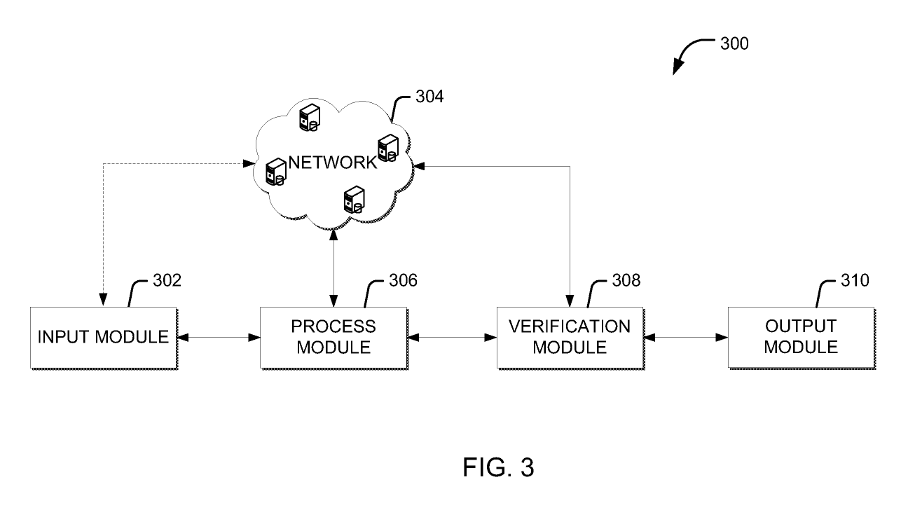

FIG. 3 depicts an exemplary system 300 for determining software installation status for computing devices in a network. An input module 302 accepts a list of computing devices connected to a network 304 and an identifier related to a software component for which the installation status is to be determined.

In the present embodiment, the input module 302 generates the list of computing devices automatically by pinging the network 304, or by using other network-monitoring tools that are known in the art. Alternatively, a user may input the list of computing devices to the input module 302 manually through a GUI.

In one embodiment, the list of computing devices is a list of all the computing devices of the network 304. In the present embodiment, however, the list of computing devices is a list of actively-connected computing devices. A process module 306 determines whether a computing device is actively-connected to the network 304 by testing the current network connection of each computing device and generates an actively-connected computing device list by performing a network connectivity test for each computing device. The computing devices for which the connectivity test result is positive are included in the list of actively-connected computing devices, while the remaining computing devices may be included in a separate list of inactive devices. The list of actively-connected computing devices excludes inactive computing devices.

The identifier relates to the software component whose installation status is to be determined on the computing devices. The user may input the identifier to the input module 302 manually through the GUI. The identifier may be a combination of a file path and a file name. The file name may be name of a file associated with the software component. The software component can be a software application, a software version, or a software patch. Alternatively, the software component can be an update to a software component.

The network 304 is a computer network including multiple computing devices connected by a wired or a wireless connection. Further, the network 304 can be a local area network (LAN), wide area network (WAN), metropolitan area network (MAN), virtual private network (VPN), storage area network (SAN), or any other network known in the art.

A verification module 308 determines the installation status of the software component for each computing device in the list of actively-connected computing devices, based on the identifier. Furthermore, the determination is a real-time activity. The verification module 308 searches for the identifier through the file system of each computing device in the list of actively-connected computing devices. The file path is searched through the network for that computing device name and current state of the software component is recorded. The user can track the number of computing devices being searched by means of a graphical progress indicator. The progress indicator can be a progress bar, a numeric marker on the GUI indicating the number of computing devices searched so far, or any other similar indicator known in the art. In addition, the current state identified is recorded with a time and date stamp.

An output module 310 produces a software installation status report based on the installation status determined by the verification module 308. The status report includes one or more status indicators, specifying the installation status for each computing device in the list of actively-connected computing devices. The status indicators may include computing device name, a string verifier, a time stamp, or a date stamp. The string verifier may include a string specifying the current state of the software component. The user can select one or more of these status indicator values for inclusion in the report. Additionally, the user may modify the status indicators by changing their associated values.

In an exemplary implementation, the user examines the report on the GUI display. Alternatively, the user may export the report data to a local computing device in a file. The user may copy or cut the entire result data from the GUI and paste in an application on the local computing device.

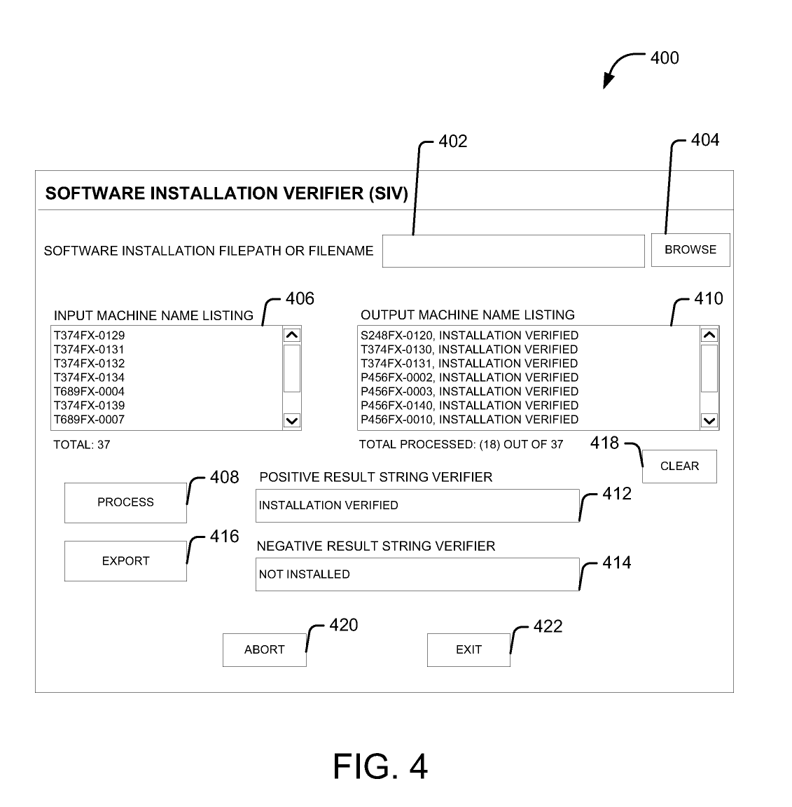

FIG. 4 is an exemplary screenshot of a GUI 400 for determining software installation status for computing devices in a network. The GUI 400 titled Software Installation Verifier (SIV) is discussed in conjunction with the system 300 of FIG. 3.

The input module 302 accepts a software identifier including a filename and file path of a software component in an input box 402. Specifically, to enter the identifier, a user positions a pointing device's cursor over the input box 402, depresses the pointing device button to select it, and then types, or copies the identifier into the input box 402. Alternatively, the user can browse for the filename or the file path by using the pointing device to generate an event. When the event occurs by pressing a browse button 404, a browsing window opens. The user can browse for the filename or the file path from an existing list of software components. The existing list includes a comprehensive list of software components such as application software, updates, or versions, malicious software and many more similar components.

Further, the input module 302 accepts a list of computing devices in an input machine name listing box 406. The user can position the pointing device's cursor over the input machine box 406, depress the pointing device button to select it, and type or copy the computing device names in the input machine box 406. The GUI 400 may also display the total number of machines in the input machine box 406. The process module 306 performs a network connectivity test for the computing devices of the input machine box 406 and generates a list of active computing devices. The user can start searching each active computing device by depressing the pointing device button on a process button 408, which activates the verification module 308 for determining the software installation status of the software component on each active computing device by searching through the file system of each active computing device. The user can track the number of computing devices being searched through a graphical progress indicator displayed on the GUI 400.

The output module 310 produces a status report based on the determined installation status in an output machine name listing box 410 including one or more status indicators, specifying installation status for each active computing device. The status indicators include computing device name, a string verifier, a time stamp, a date stamp, or any other indicator that may seem obvious to those skilled in the art. The string verifier includes a string specifying the current state of the software component. Furthermore, there are separate string verifiers for positive and negative results where the positive string verifier represents the installation status result when the software component is present and can be modified by changing the original values by entering a new verifier in a positive result string verifier box 412. Similarly, the negative string verifier represents the installation status result when the software component is absent and can be changed by the user by entering a new verifier in a negative result string verifier box 414. Further, the user can select one or more of these status indicators for inclusion in the report.

The user can export the report data from the output machine box 410 to a local computing device in a file. The user may copy or cut the entire result data from the output machine box 410 and paste in an application on the local computing device. The application can be Microsoft Word, Notepad, Microsoft Excel, Novell Open Office Write, or any other similar application known in the art. Alternatively, the user can directly export the result data into a Microsoft Excel comma-separated value spreadsheet (CSV) file by depressing the pointing device on an export button 416. Further, the user can remove the data of the output machine box 410 by depressing the pointing device on a clear button 418. In addition, the user can temporarily pause the processing by depressing the pointing device on an abort button 420. The user may terminate the processing by depressing the pointing device on an exit button 422.

It will be evident to a person skilled in the art that though the instant application illustrates the functioning of the GUI 400 using the pointing device, other devices can be also be utilized to activate various functionalities of the GUI 400. The other devices may include a keyboard or a touch pad.

The systems, methods, and products of the instant application can also be used in performing security operations, where they may identify whether or not malicious software has been installed on computing devices connected to a network. The instant application describes a software application that is very flexible to use can be installed on any local computing device, which is actively-connected to the network. A network user having administrative permissions can use the software application. Further, the software application can be used as a plug-in to other software applications having capabilities such as, executable ability, accessibility to code base, and a customizable GUI. The software application is very small in size, robust and easy to use, and consequently can be integrated and configured into other similar software applications known in the art.

The capabilities of the instant application can be implemented in software, firmware, hardware or some combination thereof. As an example, one or more aspects of the present invention can be included in an article of manufacture (e.g., one or more computer program products) having, computer usable media. The media has embodied therein, computer readable program code for providing and facilitating the capabilities of the instant application. The article of manufacture can be included as a part of a computer system or sold separately.

Additionally, at least one program storage device readable by a machine, tangibly embodying at least one program of instructions executable by the machine to perform the capabilities of the instant application can be provided.

### CONCLUSION

The instant application provides a computer implemented method for network administration. The systems, methods, and products disclosed herein provide a real-time, flexible, and user-friendly manner of determining software installation status for multiple computing devices of a network. In addition, the systems and methods integrate the benefits of a graphical user interface.

Those in the art will understand that the steps set out in the discussion above may be combined or altered in specific adaptations of the disclosure. The illustrated steps are set out to explain the embodiment shown, and it should be anticipated that ongoing technological development will change the manner in which particular functions are performed. These depictions do not limit the scope of the invention, which is determined solely by reference to the appended claims.

We claim:

1. A computer-implemented method for real-time determination of software installation status for a plurality of computing devices, the method comprising:
accepting a list of computing devices configured to access a particular network;
receiving an identifier for a software component;
determining installation status for the software component on each computing device in the list in real-time, based on the identifier; and
producing a software installation status report based on the determined installation status.

2. The method of claim 1, wherein the status report includes status indicator values for each computing device in the list.

3. The method of claim 1, wherein the identifier is one or more of:
a file path; or
a file name.

4. The method of claim 1, wherein the determining step includes searching through the file system of each computing device in the list of computing devices for the identifier.

5. The method of claim 1, wherein the producing step further includes exporting the data of the report to a local computing device file.

6. The method of claim 1, wherein the list of computing devices is a list of computing devices connected actively to the network.

7. The method of claim 6, wherein the list of computing devices connected actively to the network is generated by testing the network connection of each computing device in the network.

8. The method of claim 2, wherein the status indicators include one or more of:
a string verifier;
a time stamp; or
a date stamp.

9. The method of claim 2, further comprising selecting one or more of the status indicators for inclusion in the report.

10. The method of claim 8, wherein the status indicators are modified by changing their associated values.

11. The method of claim 1, wherein the software component is a software patch.

12. A system for real-time determination of software installation status, the system comprising:
a network, wherein a plurality of computing devices are connected to the network;
an input module configured to accept:
a computing device list including computing devices connected to the network; and
an identifier for a software component in which the installation status is to be determined;
a verification module configured to determine installation status of the software component for each computing device in the list in real-time, based on the identifier; and
an output module configured to produce a software installation status report based on the determined installation status.

13. The system of claim 12 further comprising a process module configured to:
determine whether a computing device is actively-connected to the network; and
generate an actively-connected computing device list.

14. The system of claim 12, wherein the status report includes status indicator values for each computing device.

15. The system of claim 12, wherein the identifier is one or more of:
a file path; or
a file name.

16. The system of claim 12, wherein the data in the report is exported to a local computing device file.

17. The system of claim 14, wherein the status indicators include one or more of:
a string verifier;
a time stamp; or
a date stamp.

18. The system of claim 14 further comprising selecting one or more of the status indicators for inclusion in the report.

19. The system of claim 17, wherein the status indicators are modified by changing their associated values.

20. The system of claim 12, wherein the verification module searches through the file system of each computing device of the computing device list for the identifier.

21. A computer program product stored on a computer readable medium and readable by a computing system and encoding a set of computer instructions for implementing a method for real-time determination of software installation status for a plurality of computing devices, the method comprising:
accepting a list of computing devices configured to access a particular network;
receiving an identifier for a software component;
determining installation status for the software component on each computing device in the list in real time, based on the identifier; and
producing a software installation status report based on the determined installation status.
